(19) United States
(12) Patent Application Publication
(10) Pub. No.: US 2025/0100177 A1
(43) Pub. Date: Mar. 27, 2025

(54) Tool Chain, Chain Tool, Method for Identifying a Property of a Tool Chain and System for Identifying a Property of a Tool Chain

(71) Applicant: Andreas Stihl AG & Co. KG, Waiblingen (DE)

(72) Inventor: Tobias GRAMS, Waiblingen (DE)

(21) Appl. No.: 18/895,514

(22) Filed: Sep. 25, 2024

(30) Foreign Application Priority Data
Sep. 26, 2023 (EP) 23199870.9

(51) Int. Cl. B27B 33/14; G05B 19/418

(52) U.S. Cl. CPC B27B 33/14; G05B 19/4183

(57) ABSTRACT

A tool chain has a plurality of chain links arranged in a row, wherein the plurality of chain links include at least two marked chain links. The marked chain links each have information, wherein at least one spatial sequence of the information together determines a logical sequence of at least the information. The logical sequence of at least the information forms overall information for identifying a property of the tool chain.

### CROSS REFERENCE TO RELATED APPLICATION

This application claims priority under 35 U.S.C. § 119 from European Patent Application No. 23 199 870.9, filed Sep. 26, 2023, the entire disclosure of which is herein expressly incorporated by reference.

### BACKGROUND AND SUMMARY

The invention relates to a tool chain, a chain tool comprising such a tool chain, a method for identifying a property of such a tool chain and a system for identifying a property of such a tool chain.

The invention addresses the problem of providing a tool chain, wherein the tool chain enables a property of the tool chain to be identified. Furthermore, the invention addresses the problem of providing a chain tool comprising such a tool chain, a method for identifying a property of such a tool chain and a system for identifying a property of such a tool chain.

The invention solves this problem by providing a tool chain, a chain tool having the tool chain, a method, and/or a system in accordance with the independent claim(s). Advantageous further embodiments and/or configurations of the invention are described in the dependent claims.

The tool chain according to the invention comprises or has a plurality of chain links arranged in a row or in succession. The plurality of chain links comprises or has at least two marked, in particular labeled, chain links. The marked chain links each comprise or have, in particular at least, one piece of information, in particular an information marking. At least, in particular only, one spatial sequence of the, in particular respective, information together or jointly determines or defines a logical sequence of at least, in particular only, the information. The logical sequence of at least the information forms or defines overall information, in particular an overall identification, for identifying a property, in particular a value of the property, of the tool chain.

This means that the overall information can be complex or have a high information content. This allows the property of the tool chain to be clearly and/or easily identified.

In particular, the tool chain can be designed for a chain tool, especially a hand-guided and/or motor-driven chain tool. Additionally or alternatively, the tool chain can be designed for machining a workpiece.

The plurality of chain links can be mechanically connected to each other. Additionally or alternatively, the tool chain can be closed or an endless chain.

The information can be optically detectable, in particular visible and/or legible, in particular on the outside of the marked chain links or from the outside or without dismantling the tool chain. Additionally or alternatively, the information can be the same or different.

The spatial sequence of the information can be determined by a spatial juxtaposition or a spatial sequence of the chain links. Additionally or alternatively, the spatial sequence and/or the logical sequence of at least the information can be designated as an information chain, in particular an information marking string.

In a development of the invention, the property is a type and/or a value of the plurality of chain links and/or a length and/or an authenticity of the tool chain. The type and/or the value of the plurality of chain links and/or the length of the tool chain enable(s) maintenance, repair and/or replacement of the tool chain and/or by the tool chain. Additionally or alternatively, the authenticity enables authentication of the tool chain or proof that the tool chain is an original. This therefore makes it possible to guarantee the function and/or operational reliability of the tool chain. In particular, the complex overall information provides a high level of protection against counterfeiting of the tool chain. Additionally or alternatively, the overall information can be unique, in particular in each case, or different for different tool chains of the same type, in particular in each case. Further additionally or alternatively, the overall information can be randomly generated, in particular assembled, or continued, in particular incremented. Further additionally or alternatively, identification of authenticity may be referred to as authentication.

In a development of the invention, the, in particular each, information of the, in particular each, marked chain link alone or individually does not constitute overall information for identifying the property. This allows a lot of space for the information. In particular, particularly all, the marked chain links can each have only a single information marking.

In a development of the invention, the, in particular each, piece of information, in particular the at least one information marking, is at least 0.5 times as high as the, in particular respective, marked chain link. In addition or alternatively, the, in particular each, piece of information, in particular the at least one information marking, is at least 0.5 centimeters (cm) high. This allows the information to be easily seen. In particular, the information can be at most as high as the marked chain link. Additionally or alternatively, the information can be a maximum of 5 cm high, in particular a maximum of 2 cm. Further additionally or alternatively, the height can be orthogonal in one direction to a row and/or movement direction of the tool chain.

In a development of the invention, the information, in particular each piece of information, in particular the at least one information marking, is embossed or lasered into the chain link, in particular each marked chain link. This enables good durability or good protection of the information against wear by machining by means of the tool chain, in particular in contrast to information that is glued and/or printed on. This means that the information can be easily detected visually.

In a development of the invention, the, in particular each, piece of information is or contains at least one character, in particular a numeral and/or a letter, and/or at least one symbol and/or at least one code, in particular a 2D code, in particular a DataMatrix code. In particular, the numeral may be multi-digit and/or hexadecimal. Additionally or alternatively, the symbol may comprise, in particular may be, a triangle and/or a circle.

In a development of the invention, the plurality of chain links comprises or has different types of chain links, in particular driving links, connecting links, riveting links and/or cutting links. In particular, all of the marked chain links are of the same type, in particular connecting links. Additionally or alternatively, at least 20 percent (%), in particular at least 90%, in particular 100%, of the chain links of one of the types, in particular the connecting links, each have information. This makes it easy to manufacture the tool chain. In addition or alternatively, the connecting links enable good durability or good protection of the information against wear and/or good optical detectability of the information. In particular, especially in a row and/or movement direction of the tool chain, right chain links and, in particular in the row direction, left chain links can be different types of chain links. In particular, the marked chain links can be right-hand connecting links. Additionally or alternatively, at least 20%, in particular at least 90%, in particular 100%, of the right-hand connecting links each have information.

A chain link designed as a rivet link can expediently have a rivet or be a rivet that has opposing, for example mushroom-shaped, widened rivet heads. At least one of the rivet heads can be widened in a reshaping manner to connect other chain links, in particular by riveting, in particular after the chain links to be connected have been arranged in the assembly position.

If the marked chain link is a rivet link, the information, in particular any information, in particular the at least one information marking, may be present on at least one of the rivet heads of this rivet link. The information present on the rivet head or the information marking present on the rivet head can correspond to a rivet head shape of the rivet head, in particular a rivet head detail of the rivet head. The rivet head shape of the rivet head can be generated after or before the chain links to be connected are arranged in the assembly position and/or before or after riveting.

A chain link designed as a drive link can expediently have recesses, in particular spherical caps, for receiving lubricant. Such a recess for receiving lubricant can also be referred to synonymously as a lubricant pocket.

If the marked chain link is a driving link, in an embodiment of the invention the, in particular each, item of information, in particular the at least one information marking, can correspond to a number and/or a formation of the recesses of this driving link.

Expediently, the tool chain has a guide area, in particular at least on its drive links. In an embodiment of the invention, which is in particular an alternative to the above embodiment, the guide area is free of information, in particular information markings. In particular in this case, any markings and/or recesses for receiving lubricant in the region of the guide area cannot represent any information, in particular information markings for the spatial sequence. The guide area can be guided on a guide rail of a chain tool, in particular if the tool chain is mounted on the chain tool. If the tool chain is guided on the guide rail, the guide area of the tool chain can be concealed by the guide rail. In other words: The information, in particular the information markings, can be present outside the guide area in such a way that they can also be detected when the tool chain is mounted on the chain tool and/or guided on the guide rail. In particular, recesses, especially spherical caps, used for receiving lubricant can be covered by drive links of the tool chain if the tool chain is mounted on the chain tool and/or guided on the guide rail. If the tool chain is designed as an endless chain, the guide area can be arranged radially on the inside in particular.

In a development, in particular an embodiment, of the invention, the spatial sequence of the information and at least one spacing, in particular a number of unmarked or unlabeled chain links, in particular of the same type as the marked chain links, between the marked chain links, in particular two of the marked chain links in each case, and/or at least one position of the information, in particular of the at least one information marking, on the marked chain link together determine the logical sequence of the information and of the at least one spacing and/or of the at least one position. The logical sequence of the information and the at least one distance and/or the at least one position forms the overall information. This allows the overall information to be particularly complex or to have a particularly high information content.

In particular, the plurality of chain links may comprise at least two marked chain links. In addition or alternatively, the information, in particular the information markings, can be from a set, in particular a defined set, of at least two different pieces of information, in particular information markings.

In a development of the invention, the plurality of chain links comprises or has at least eight marked chain links. Additionally or alternatively, the information, in particular the information markings, are from a, in particular defined, set of at least eight different pieces of information, in particular information markings. This enables a particularly large number of possibilities for the overall information, in particular its information content. In particular, the set can be referred to as a marking set.

Expediently, the information, in particular the information markings, consist of at least two, in particular defined, sets of at least two different pieces of information each, in particular information markings. The sets can be referred to as different marking sets. The at least two sets can each have a marking type in common for their information, in particular information markings. One such marking type may comprise characters, in particular numerals and/or letters. Alternatively or additionally, one, in particular other, marking type may comprise codes, in particular 2D codes, in particular DataMatrix codes. Alternatively or additionally, one, in particular other, marking type may comprise rivet head formations, in particular rivet head details. Alternatively or additionally, one, in particular other, marking type may comprise numbers and/or formations of recesses, in particular spherical caps, for receiving lubricant. It is understood that alternative or additional, in particular other, marking types may be provided. The information from at least two sets can form a common spatial sequence and/or parallel spatial sequences. In this way, a particularly high information density can be achieved, in particular with reference to a limited detection range, in particular a detection device for detecting the at least spatial sequence.

In a development of the invention, the tool chain is a cutting chain, in particular a saw chain. For such a tool chain, a guarantee of function and/or operational safety is particularly advantageous.

In a development of the invention, at least the spatial sequence of the information, in particular only, on one, in particular only, common side, in particular outer side, of the tool chain determines the logical sequence of at least the information. In other words, in particular all, the information, in particular the information markings, are arranged on the common side of the tool chain, in particular spatially. This enables simple optical detection, in particular by means of just a single image.

The chain tool according to the invention comprises or has a tool chain, in particular the tool chain as described above. In particular, the chain tool is a hand-guided, in particular hand-carried, and/or motor-driven chain tool. In particular, the information can be optically detectable, in particular visible and/or readable, in particular from the outside or without dismantling the chain tool. Additionally or alternatively, hand-guided, in particular hand-carried, chain tool can mean that the chain tool can have a mass of a maximum of 50 kilograms (kg), in particular of a maximum of 20 kg, in particular of a maximum of 10 kg, in particular of a maximum of 5 kg, and/or of a minimum of 1 kg, in particular of a minimum of 2 kg. Further in addition or alternatively, the chain tool can also have a drive motor system for driving or moving the tool chain.

In a development of the invention, the chain tool is a gardening, forestry and/or construction chain tool, in particular a cutting tool, in particular a chainsaw.

The method according to the invention, in particular an automatic method, is designed or configured for identifying, in particular automatically, a property of a tool chain, in particular the tool chain, as described above and/or a tool chain exhibited by a chain tool, in particular the chain tool, as described above. The method comprises or has the steps of: a) detecting, in particular automatically and/or optically, at least the spatial sequence of the information; b) determining, in particular automatically, the logical sequence of at least the information based on at least the detected spatial sequence of the information, wherein the logical sequence of at least the information forms the overall information for identifying the property of the tool chain; c) Identifying, in particular automatically identifying, the property of the tool chain based on the overall information formed. In particular, step b) can be performed after step a). Additionally or alternatively, step c) may be performed after step b).

A multi-stage database query can expediently be performed when carrying out step b) and/or step c). In particular, the multi-stage database query may comprise a first query stage and a second query stage following the first query stage in terms of time. The query stages may differ in terms of the complexity and/or acquisition speed of the information, in particular information markings, acquired in accordance with step a). Thus, in the first query stage, the database query can be performed for information, in particular information markings, which can be captured quickly and/or have a relatively low complexity. In the second query stage, the database query can be performed for information, in particular information markings, which can be captured less quickly and/or are more complex than the information, in particular information markings, handled in the first query stage. For example, characters, in particular numerals and/or letters, can be captured more quickly and/or are less complex than the formation of recesses, in particular spherical caps, for receiving lubricant.

The, in particular electrical, system according to the invention is designed or configured for, in particular automatically, identifying a, in particular the, property of a, in particular the, tool chain as described above and/or a, in particular the, tool chain exhibited by a, in particular the, chain tool as described above. The system comprises or has a, in particular electrical and/or optical, detection device, a, in particular electrical, determination device and an, in particular electrical, identification device. The detection device is designed or configured for detecting, in particular automatically and/or optically, the at least spatial sequence of the information. The determination device is designed or configured for determining, in particular automatically, the logical sequence of at least the information based on at least the detected spatial sequence of the information, wherein the logical sequence of at least the information forms the overall information for identifying the property of the tool chain. The identification device is designed or configured to identify, in particular automatically, the property of the tool chain based on the overall information formed. In particular, the system can be designed to carry out a method, in particular the method as described above. Additionally or alternatively, the system can be designed separately from the tool chain and/or the chain tool. Further additionally or alternatively, the detection device may comprise, in particular be, a camera, in particular a digital camera. Further additionally or alternatively, the determination device may comprise, in particular be, a computing device. Further additionally or alternatively, the identification device may have a computing device and/or a storage device, in particular a database. In particular, the overall information can be assigned to the property of the tool chain in the identification device, in particular by a manufacturer, in particular an original manufacturer, of the tool chain. Further additionally or alternatively, the system may comprise a mobile, in particular portable or hand-carried, device, wherein the device may at least partially comprise the detection device, the determination device and/or the identification device. In particular, the mobile device may comprise, in particular be, a smartphone and/or a smartwatch.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of the outside of a tool chain according to an embodiment of the invention;

FIG. 2 is a schematic view of the upper side of the tool chain of FIG. 1;

FIG. 3 is a schematic view of an opposite outer side of the tool chain of FIG. 1;

FIG. 4 is a schematic view of a method and system according to an embodiment of the invention;

FIG. 5 is a schematic view of a chain tool comprising the tool chain of FIG. 1;

FIG. 6 is a schematic view of an outer side of a further tool chain according to an embodiment of the invention; and

FIG. 7 is a schematic view of a drive link for the tool chain according to FIG. 1.

### DETAILED DESCRIPTION OF THE DRAWINGS

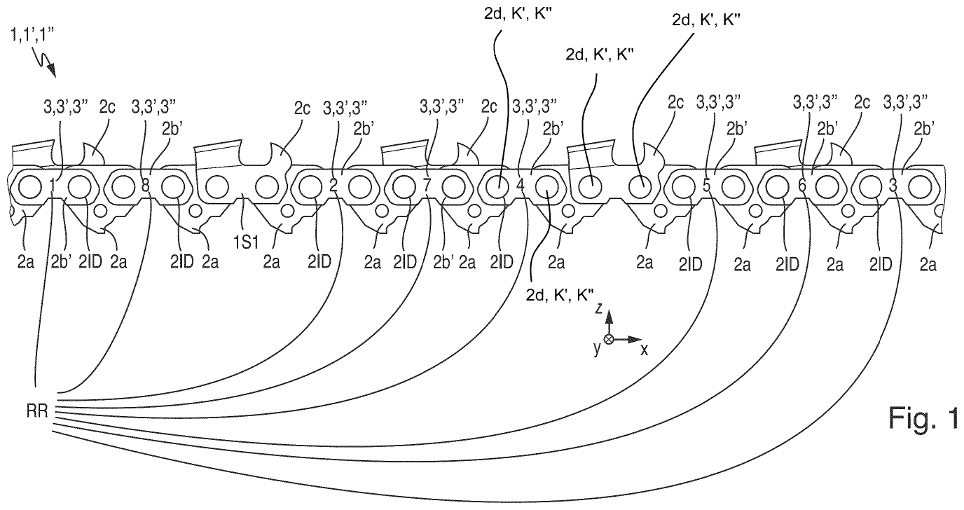

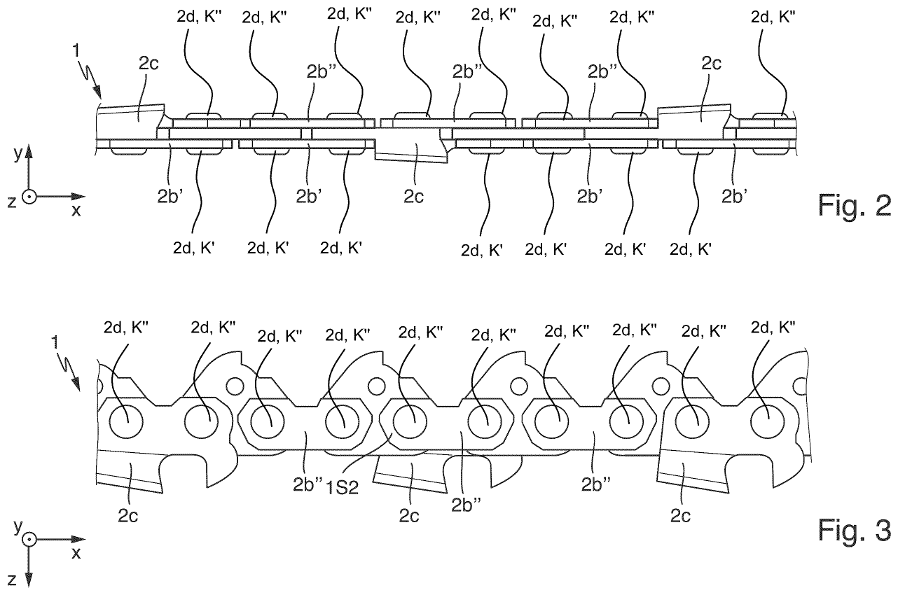

FIGS. 1 to 5 and 6 show, in particular in each case, a tool chain 1. The tool chain 1 has a plurality of chain links 2 arranged in a row. The plurality of chain links 2 has at least two marked chain links 2ID. The marked chain links 2ID each have information 3. At least, in FIGS. 1 to 5 only, a spatial sequence RR of the information together determines a logical sequence LR of at least, in FIGS. 1 to 5 only, the information 3. The logical sequence LR of at least the information 3 forms overall information ID for identifying a property EI of the tool chain 1.

In detail, the tool chain 1 is a cutting chain 1′, in particular a saw chain 1″.

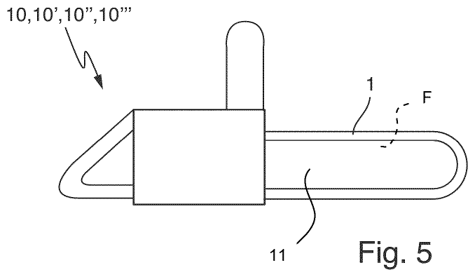

Furthermore, FIG. 5 shows a chain tool 10. The chain tool 10 has the tool chain 1.

In particular, the chain tool 10 is a hand-guided and/or motor-driven chain tool.

In detail, the chain tool 10 is a garden, forestry and/or construction chain tool 10′, in particular a cutting tool 10″, in particular a chainsaw 10″.

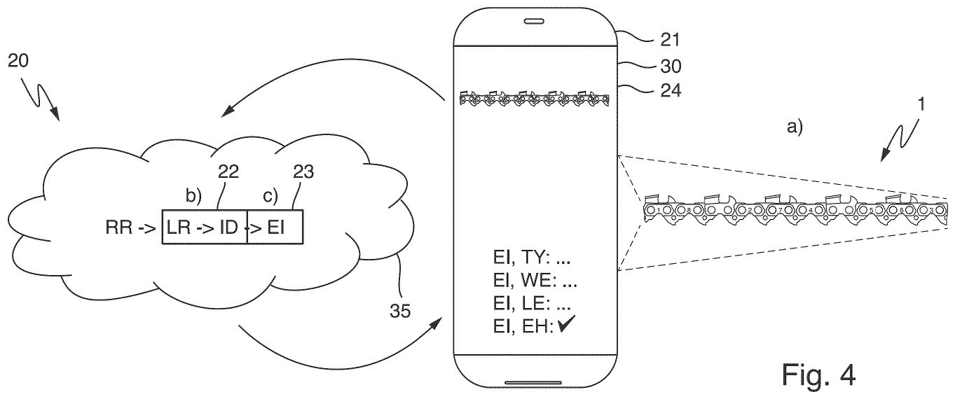

In addition, FIG. 4 shows a system 20 and a method for identifying the property EI of the tool chain 1, in particular exhibited by the chain tool 10.

The system 20 has a detection device 21, a determination device 22 and an identification device 23. The detection device 21 is designed to detect the at least spatial sequence RR of the information 3. The determination device 22 is designed to determine the logical sequence LR of at least the information 3 based on at least the detected spatial sequence RR of the information 3, wherein the logical sequence LR of at least the information 3 forms the overall information ID for identifying the property EI of the tool chain 1. The identification device 23 is designed to identify the property EI of the tool chain 1 based on the overall information ID formed.

The method has the following steps: a) detecting at least the spatial sequence RR of the information 3, in particular by means of the detection device 21; b) determining the logical sequence LR of at least the information 3 based on at least the detected spatial sequence RR of the information 3, in particular by means of the determination device 22, wherein the logical sequence LR of at least the information 3 forms the overall information ID for identifying the property EI of the tool chain 1; c) identifying the property EI of the tool chain 1 based on the overall information ID formed, in particular by means of the identification device 23.

In the exemplary embodiment shown, the information 3 can be detected optically.

Furthermore, in the exemplary embodiment shown, the detection device 21 is an optical detection device, in particular in the form of a digital camera.

In addition, in the exemplary embodiment shown, the detection device 21 is a user-operated detection device or input device, in particular in the form of a touchscreen.

In alternative exemplary embodiments, the detection device can be either an optical detection device or a user-actuatable detection device.

In addition, in the exemplary embodiment shown, the system 20 comprises a mobile device 30, in particular in the form of a smartphone. The mobile device 30 comprises the detection device 21.

Furthermore, the system 20 comprises a stationary device 35, in particular in the form of a cloud server. The stationary device 35 comprises the determination device 22 and the identification device 23.

In addition, the detection device 21 and the determination device 22 or the mobile device 30 and the stationary device 35 are designed for transmitting, in particular wirelessly, at least the detected spatial sequence RR of the information 3, in the exemplary embodiment shown in particular transmitting an image and/or a user input of at least the spatial sequence RR of the information 3.

The system 20 also has an output device 24, in particular an electrical output device. This output device 24 is designed to output the identified property EI, in particular automatically.

The method comprises the step of: outputting, in particular automatically outputting, the identified property EI, in particular to a user, in particular by means of the output device 24.

In the exemplary embodiment shown, the output device 24 is an optical output device, in particular in the form of a display.

In addition, the mobile device 30 comprises the output device 24.

Furthermore, the identification device 23 and the output device 24 or the stationary device 35 and the mobile device 30 are designed to transmit, in particular to transmit, in particular wirelessly, the identified property EI.

In addition, the system 20 or the method is designed to recognize whether the tool chain 1 has been lengthened or shortened and to take this into account when identifying the property EI, and/or to identify in such a way that a lengthening or shortening of the tool chain 1 does not cause an error, in particular a safety-relevant error, and/or to output if identification is not possible, in particular safely.

In detail, the property EI is a type TY and/or a value WE of the plurality of chain links 2 and/or a length LE and/or an authenticity EH of the tool chain 1.

Furthermore, the information 3 of the marked chain link 2ID alone does not constitute overall information for identifying the property EI.

In addition, the information 3 is at least 0.5 times as high as the marked chain link 2ID and/or at least 0.5 cm high, in particular in a direction z orthogonal to a row direction x of the tool chain 1.

Furthermore, in the exemplary embodiment shown, the information 3 is embossed into the marked chain link 2ID.

In alternative exemplary embodiments, the information can be lasered into the marked chain link.

Furthermore, in FIGS. 1 to 5, the information 3 is a character 3′, in particular a numeral 3″.

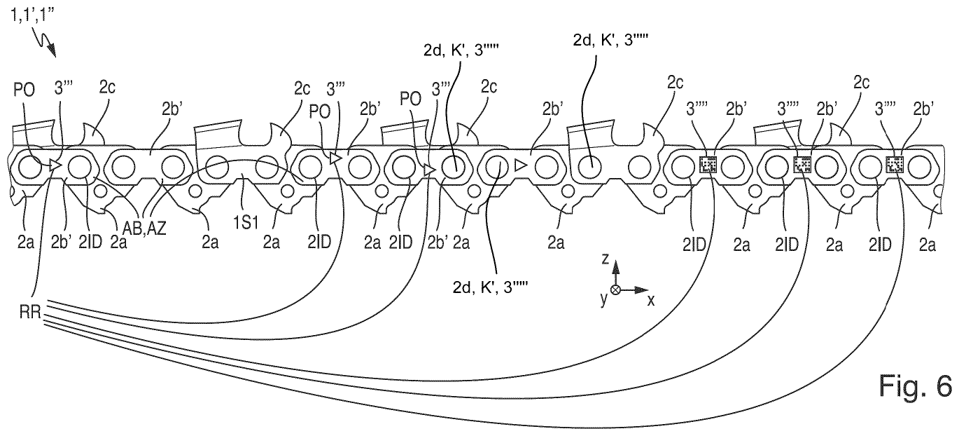

In FIG. 6, the information 3 is a symbol 3′ and/or a code 3″, in particular a 2D code, especially a DataMatrix code.

In alternative exemplary embodiments, the character can be a letter.

Furthermore, in the exemplary embodiment shown, the plurality of chain links 2 has different types of chain links 2a, 2b′, 2b″, 2c, 2d, in particular drive links 2a, in particular in the row direction x right and left, connecting links 2b′, 2b″, cutting links 2c and/or riveting links 2d.

Each riveting link 2d can have a rivet or be a rivet and have widened rivet heads K′, K″ opposite each other. The rivet heads K′, K″ may face each other along a direction y, wherein the direction y is orthogonal to the row direction x and the direction z. At least one of the rivet heads K′, K″ can be widened to connect other chain links 2a, 2b′, 2b″, 2c by reshaping, in particular by riveting, in particular after the chain links 2a, 2b′, 2b″, 2c to be connected have been arranged in the assembly position.

In addition, the marked chain links 2ID are of the same type, in particular the right-hand connecting links 2b′.

In addition, at least 20 percent %, in FIGS. 1 to 5 100%, of the chain links 2 of one of the types, in particular the right-hand connecting links 2b′, each have information 3.

In addition, in FIG. 6, the spatial sequence RR of the information 3 and at least one spacing AB, in particular a number AZ of unmarked chain links 2, in particular of the same type as the marked chain links 2ID, in the exemplary embodiment shown the right-hand connecting links 2b′, between the marked chain links 2ID and/or at least one position PO of the information 3 on the marked chain link 2ID together determine the logical sequence LR of the information 3 and of the at least one spacing AB and/or of the at least one position PO. The logical sequence LR of the information 3 and the at least one distance AB and/or the at least one position PO forms the overall information ID.

Furthermore, in FIGS. 1 to 5, the plurality of chain links 2 has at least eight marked chain links 2ID.

In addition, the information 3 is from a set of at least eight different pieces of information 3, in FIG. 1 from the set “1”, “2”, “3”, “4”, “5”, “6”, “7”, “8”.

In detail, in FIG. 1 the marked chain links 2ID have the information 3 “1”, “8”, “2”, “7”, “4”, “5”, “6”, “3”. The spatial sequence RR of the information 3 “1”, “8”, “2”, “7”, “4”, “5”, “6”, “3” together determines the logical sequence LR of the information 3 “18274563”. The logical sequence LR of the information 3 “18274563” forms the overall information ID “18274563”.

If in FIG. 1 a distance AB, in particular the number AZ of unmarked chain links 2, in particular of the same type as the marked chain links 2ID, in the exemplary embodiment shown the right-hand connecting links 2b′, between the marked chain links 2ID having the information 3 “1” and “8” were one, as shown in FIG. 6, then for example for the one distance AB “0” could be inserted between the information 3 “1” and “8” of the marked chain links 2ID. The logical sequence LR of the information 3 and the at least one distance AB would therefore be “108274563”. The total information ID would therefore be “108274563”.

If in FIG. 1 a position PO of information 3 “1” were in the middle, a position PO of information 3 “8” at the top and a position PO of information 3 “2” at the bottom, as shown in FIG. 6, then, for example, “m” could be inserted after information 3 “1” for the position PO in the middle, “o” after information 3 “8” for the position PO at the top and “u” after information 3 “2” for the position PO at the bottom. The logical sequence LR of information 3 and at least one position PO would therefore be “1m8o2u74563”. The total information ID would therefore be “1m8o2u74563”.

In particular, the at least one distance AB and/or the at least one position PO could or would need to be taken into account more when the detection device 21 is designed in the form of an optical detection device and less when the detection device 21 is designed in the form of a user-actuated detection device.

Furthermore, in the exemplary embodiment shown, at least the spatial sequence RR of the information 3 on a common side 1S1 of the tool chain 1 determines the logical sequence LR of at least the information 3.

For example, at least one marked chain link 2 can be a rivet link 2d, in particular as an alternative or in addition to marked chain links 2 of other types. With regard to the marked chain link 2 formed by the rivet link 2d, the information 3 can be present on at least one of the rivet heads K′, K″ of this rivet link 2d. The information 3 present on the rivet head K, K′ corresponds, for example, to a rivet head shape 3″″′ of the rivet head K′, K″, in particular a rivet head detail of the rivet head K′, K″. The rivet head shaping 3″″′ of the rivet head K′, K″ is generated, for example, before the chain links 2 to be connected are arranged in the assembly position. Alternatively or additionally, the rivet head shaping 3″″′ can be generated after or during riveting.

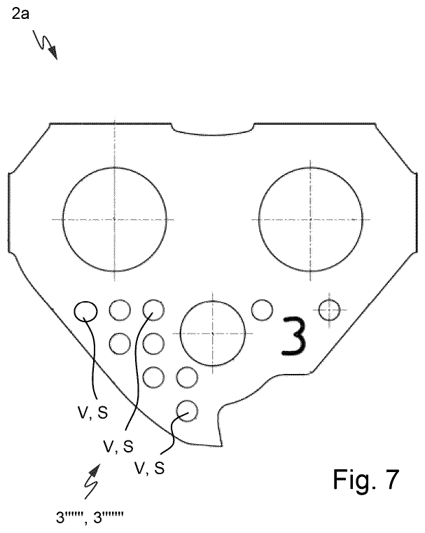

For example, at least one marked chain link 2 can be a drive link 2a with recesses V, in particular spherical caps S, for receiving lubricant. In this case, the information 3 can correspond to a number 3″″′ of recesses V of this drive link 2a. Alternatively or additionally, the information 3 can correspond to a formation 3″″′ of the recesses V of this drive link 2a. FIG. 7 shows an example of such a driving link 2a with a number 3″″′ of recesses arranged in a formation 3″″″. In the case of other numbers 3″″″ and/or formations 3″″″ selected recesses V can be omitted, for example, based on the example shown in FIG. 7.

For example, information 3 can consist of at least two sets of at least two different pieces of information 3. The sets can each form a separate marking set, wherein the marking sets are each based on a common marking type. The information 3 from at least two sets can, for example, form a common spatial sequence RR or parallel spatial sequences RR. In this way, a particularly high information density can be achieved, in particular with reference to a detection area, in particular the detection device 21 for detecting the at least spatial sequence RR.

For example, the tool chain 1 has a guide area F that is free of information 3, in particular information markings. The guide area F can be guided on a guide rail 11 of a chain tool 10, in particular if the tool chain 1 is guided by the chain tool 10. If the tool chain 1 is guided on the guide rail 11, the guide area F of the tool chain 1 can be covered by the guide rail 11; see FIG. 5. In other words, the information 3, in particular the information markings, can be present outside the guide area F in such a way that they can also be detected when the tool chain 1 is guided on the guide rail 11, in particular from the outside. In particular, any markings on the tool chain 1 within the guide area F are not information 3 in this example scenario. If the tool chain 1 is designed as an endless chain, for example as shown in FIG. 5, the guide area F can be arranged radially on the inside.

For example, when carrying out step b) and/or step c) of the method already explained above by way of example, a multi-stage database query can be carried out. The multi-stage database query may comprise a first query stage and a second query stage following the first query stage. It is understood that the second query stage can be followed by further query stages. The query stages may differ, for example, in terms of the complexity and/or acquisition speed of the information 3, in particular information markings, acquired in accordance with step a). For example, in the first query stage, the database query can be performed for information 3, in particular information markings, which can be captured relatively quickly and/or have a relatively low complexity. In the second query stage, the database query can be performed, for example, for information 3, in particular information markings, which can be captured less quickly and/or are more complex than the information 3, in particular information markings, processed in the first query stage. For example, characters, in particular numerals and/or letters, can be captured more quickly and/or are less complex than the formation of recesses V, in particular spherical caps S, for receiving lubricant.

As the exemplary embodiments shown and explained above make clear, the invention provides an advantageous tool chain, wherein the tool chain enables identification of a property of the tool chain. Furthermore, the invention provides an advantageous chain tool comprising such a tool chain, an advantageous method for identifying a property of such a tool chain and an advantageous system for identifying a property of such a tool chain.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A tool chain, comprising:
a plurality of chain links arranged in a row,
wherein the plurality of chain links comprises at least two marked chain links, wherein the at least two marked chain links each comprise information, and
wherein at least one spatial sequence of the information together determines a logical sequence of at least the information, wherein the logical sequence of at least the information forms overall information for identifying a property of the tool chain.

2. The tool chain according to claim 1,
wherein the property is a type and/or a value of the plurality of chain links, and/or a length and/or an authenticity of the tool chain.

3. The tool chain according to claim 1,
wherein the information of one marked chain link alone does not constitute the overall information for identifying the property.

4. The tool chain according to claim 1,
wherein the information is at least 0.5 times as high as the marked chain link, and/or
wherein the information is at least 0.5 cm high.

5. The tool chain according to claim 1,
wherein the information is embossed or lasered into the marked chain link.

6. The tool chain according to claim 1,
wherein the information is at least one character, at least one symbol, and/or at least one code.

7. The tool chain according to claim 6, wherein
the character is a numeral and/or a letter,
the code is a DataMatrix code.

8. The tool chain according to claim 1, wherein the plurality of chain links comprises different types of chain links, and wherein
the at least two marked chain links are of the same type, and/or
at least 20% of the chain links of one of the different types, each have information.

9. The tool chain according to claim 8, wherein the different types of chain links comprise drive links, connecting links and/or cutting links, and wherein
the marked chain links are connecting links, and/or
at least 90% of the chain links of one of the different types, each have information.

10. The tool chain according to claim 8,
wherein the spatial sequence of the information and at least one distance between the marked chain links and/or at least one position of the information on the marked chain link together determine the logical sequence of the information and of the at least one distance and/or of the at least one position, and
wherein the logical sequence of the information and of the at least one distance and/or of the at least one position forms the overall information.

11. The tool chain according to claim 10, wherein the at least one distance comprises a number of unmarked chain links of the same type as the marked chain links.

12. The tool chain according to claim 1,
wherein the plurality of chain links comprises at least eight marked chain links, and/or
wherein the information is from a set of at least eight different pieces of information.

13. The tool chain according to claim 1,
wherein the tool chain is a cutting chain.

14. The tool chain according to claim 1,
wherein at least the spatial sequence of the information on a common side of the tool chain determines the logical sequence of at least the information.

15. A hand-guided and/or motor-driven chain tool comprising a tool chain according to claim 1.

16. The hand-guided and/or motor-driven chain tool according to claim 15,
wherein the chain tool is a garden, forestry and/or construction chain tool.

17. A method for identifying a property of a tool chain having a plurality of chain links arranged in a row, wherein the plurality of chain links comprises at least two marked chain links, wherein the at least two marked chain links each comprise information, and wherein at least one spatial sequence of the information together determines a logical sequence of at least the information,
the method comprising the steps of:
a) detecting at least the spatial sequence of the information;
b) determining the logical sequence of at least the information based on at least the detected spatial sequence of the information, wherein the logical sequence of at least the information forms overall information for identifying the property of the tool chain; and
c) identifying the property of the tool chain based on the overall information formed.

18. A system for identifying a property of a tool chain, wherein the tool chain comprises:
a plurality of chain links arranged in a row,
wherein the plurality of chain links comprises at least two marked chain links, wherein the at least two marked chain links each comprise information, and
wherein at least one spatial sequence of the information together determines a logical sequence of at least the information, wherein the logical sequence of at least the information forms overall information for identifying a property of the tool chain,
the system comprising:
a detection device, wherein the detection device is designed to detect the at least one spatial sequence of the information;
a determination device, wherein the determination device is designed to determine the logical sequence of at least the information based on at least the detected spatial sequence of the information, wherein the logical sequence of at least the information forms the overall information for identifying the property of the tool chain; and
an identification device, wherein the identification device is designed to identify the property of the tool chain based on the overall information formed.
